(19) United States
(12) Patent Application Publication
(10) Pub. No.: US 2015/0089665 A1
(43) Pub. Date: Mar. 26, 2015

(54) Document Management Server That Reduces Information Leakage of Non-Public Document Information

(71) Applicant: Kyocera Document Solutions Inc., Osaka (JP)

(72) Inventor: Takashi Nomura, Osaka (JP)

(21) Appl. No.: 14/492,404

(22) Filed: Sep. 22, 2014

(30) Foreign Application Priority Data
Sep. 24, 2013 (JP) 2013-196773

(51) Int. Cl. G06F 21/60

(52) U.S. Cl. CPC G06F 21/60; G06F 21/604
USPC 726/27

(57) ABSTRACT

A document management server includes a document information managing unit, a location information acquisition unit, and an information transmitting unit. The document information managing unit controls public document information and non-public document information. The public document information is freely browsable. The non-public document information is browsable inside a permission area. The location information acquisition unit acquires location information of a mobile terminal to browse the non-public document information. The information transmitting unit determines whether or not the mobile terminal is inside the permission area based on the acquired location information and transmits the non-public document information to the mobile terminal while the mobile terminal is determined to be in the permission area.

### CROSS-REFERENCE TO RELATED APPLICATION

This application is based upon, and claims the benefit of priority from, corresponding Japanese Patent Application No. 2013-196773 filed in the Japan Patent Office on Sep. 24, 2013, the entire contents of which are incorporated herein by reference.

### BACKGROUND

Unless otherwise indicated herein, the description in this section is not prior art to the claims in this application and is not admitted to be prior art by inclusion in this section.

Document information constituted of images and characters or similar information under control of companies may include non-public document information such as confidential information regulated with respect to browsing. Recently, use of the digitized document information has been expanded. Thus; as convenience increases, the risk of information leakage of the non-public document information has also been increasing.

As information leakage countermeasures, for example, there is provided a technique that adds location information to the images taken by digital cameras or similar device and prohibits print output if the images are determined to be a secret object (non-public document information) based on the location information at the time of imaging.

### SUMMARY

A document management server according to an embodiment of the disclosure includes a document information managing unit, a location information acquisition unit, and an information transmitting unit. The document information managing unit controls public document information and non-public document information. The public document information is freely browsable. The non-public document information is browsable inside a permission area. The location information acquisition unit acquires location information of a mobile terminal to browse the non-public document information. The information transmitting unit determines whether or not the mobile terminal is inside the permission area based on the acquired location information and transmits the non-public document information to the mobile terminal while the mobile terminal is determined to be in the permission area.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a configuration of document browsing system according to a first embodiment of the disclosure;

FIG. 2 illustrates a configuration of a document management server and a mobile terminal of the document browsing system according to the first embodiment;

FIG. 3 illustrates steps of a document browsing process by the document browsing system according to the first embodiment;

FIG. 4 illustrates a configuration of a document management server and a mobile terminal of the document browsing system according to a second embodiment; and

FIG. 5 illustrates steps of a document browsing process by the document browsing system according to the second embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

An object to improve information leakage countermeasures for digitized document information is ensured with a document management server that ensures browsing non-public document information with a mobile terminal while the mobile terminal is situated inside a permission area.

Specifically, the document management server includes a server storage unit, a location information acquiring unit, and an information transmitting unit. The server storage unit stores public document information that is freely browsable, and the non-public document information that is browsable inside a permission area. The location information acquiring unit acquires location information of the mobile terminal to browse the non-public document information. The information transmitting unit transmits the non-public document information to the mobile terminal while the mobile terminal is situated inside the permission area based on the acquired location information.

The document management server is applicable to a server functional unit included in an image forming apparatus and an independent server unit.

In the document browsing system that employs this document management server, the mobile terminal includes a browse requesting unit and a display processing unit. The browse requesting unit requests to browse the non-public document information by transmitting location information of own apparatus to the document management server. The display processing unit displays the non-public document information received from the document management server on the display.

Hereinafter, the first embodiment of the disclosure will be described referring to the drawings.

### Configuration of Document Browsing System

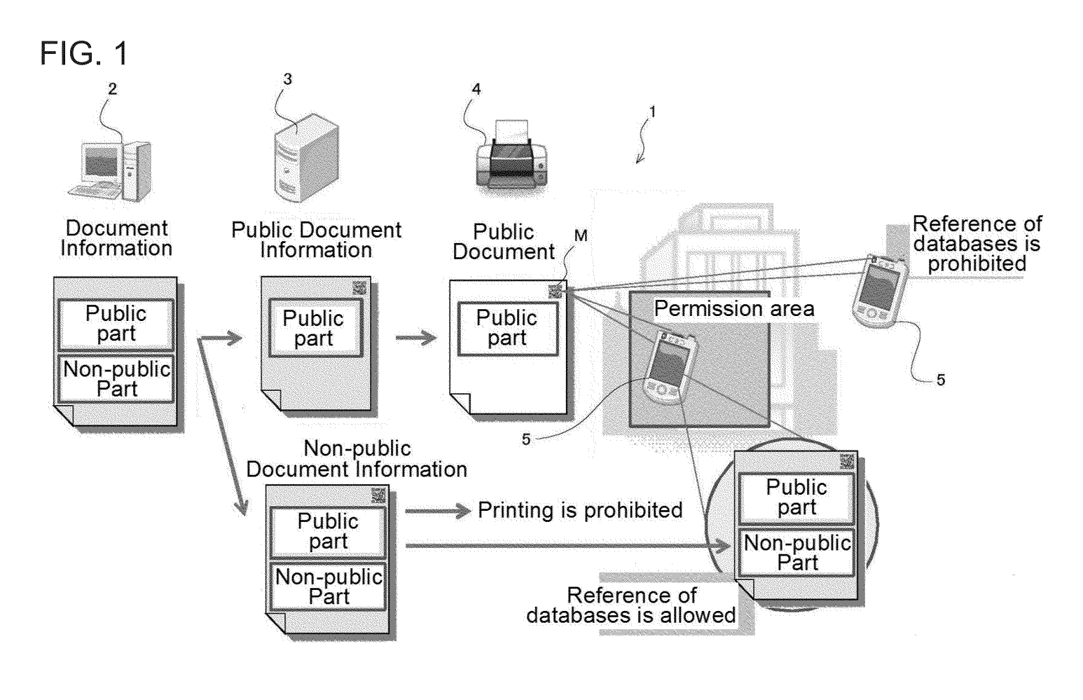

FIG. 1 illustrates a configuration of a document browsing system according to the first embodiment of the disclosure. A document browsing system 1 is connected to a user terminal 2, a document management server 3, an image forming apparatus 4, and a mobile terminal 5 via a network.

The user terminal 2 is an information processor such as a personal computer and generates document information constituted of images and characters. In the first embodiment, a public part that is freely browsable, and a non-public part that is browsable inside a permission area, in the same document information are respectively generated as the public document information and the non-public document information.

Print output of the public document information of the first embodiment is ensured to be freely browsable. On the other hand, print output of the non-public document information is prohibited to prevent from leakage.

The public document information and the non-public document information can be generated with the use of application programs. For example, in generating document information, a user specifies a public part to generate public document information that consists of the specified public part and does not include non-public document information that has not been specified, and generates non-public document information as whole document information including the non-public part and the public part.

The public document information and non-public document information generated are transmitted to the document management server 3 and stored.

The document management server 3 is an information processor and transmits the non-public document information to the mobile terminal 5 situated inside a browsable permission area and also transmits the public document information to the image forming apparatus 4 upon request. The document management server 3 will be described later in detail.

The image forming apparatus 4, for example, is a printer and a digital multi-functional peripheral that performs print output of the public document information received from the document management server 3. The print output is executed by the user request for the print output of the public document information at the image forming apparatus 4 or the user terminal.

The mobile terminal 5, for example, is a portable information processing terminal such as multi-functional telephone set that ensures browsing the non-public document information received from the document management server 3 on the screen. The mobile terminal 5 will be described later in detail.

### Document Management Server and Mobile Terminal

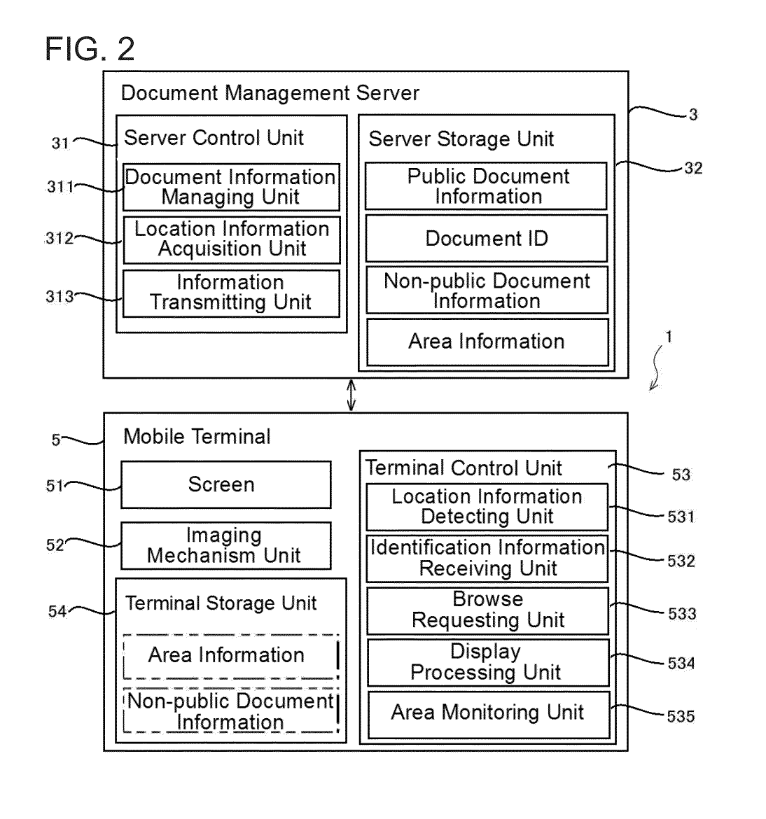

FIG. 2 illustrates a configuration of the document management server and the mobile terminal of the document browsing system according to the first embodiment.

The document management server 3, as illustrated in FIG. 2, includes a server control unit 31, a server storage unit 32, and similar unit.

The server control unit 31 is an arithmetic device such as Central Processing Unit (CPU) and controls the performance of the document management server 3. The server storage unit 32 includes a Read Only Memory (ROM) that stores programs, a Random Access Memory (RAM) as a work area, and a Hard Disk Drive (HDD) as an auxiliary storage device.

The document management server 3 of the first embodiment performs as a document information managing unit 311, a location information acquisition unit 312, and an information transmitting unit 313 through the execution of the programs in the server storage unit 32 by the server control unit 31.

The document information managing unit 311 ensures document information managing functions, and stores and controls both the public document information received from the user terminal 2 and the non-public document information in the server storage unit 32.

The document information managing unit 311 also controls document identification information (hereinafter referred to as “document ID”) to identify the non-public document information. The document ID of the first embodiment is managed such that the document ID can be printed out on a paper sheet by the image forming apparatus 4 associated with the public document information included in the same document information with the non-public document information. When the document ID is printed out, it takes the form of a mark M (see FIG. 1) such as a two-dimensional barcode. However, the document ID may be printed out on the paper sheet as character strings such as numerals.

The document information managing unit 311 manages area information that specifies the range of the permission area where the non-public document information is browsable. In the area information, the area where security is ensured and browsing of the non-public document information is permitted, such as meeting rooms of a company that controls the non-public document information, is preliminary set and stored in the server storage unit 32.

The location information acquisition unit 312 ensures location information acquisition functions and acquires the location information of the mobile terminal 5 to browse the non-public document information. Specifically, as described later, the location information acquisition unit 312 receives and acquires the location information from the mobile terminal 5 that requests to browse the non-public document information.

The information transmitting unit 313 ensures information transmitting functions and determines whether or not the mobile terminal 5 is inside the permission area based on the acquired location information of the mobile terminal 5. The information transmitting unit 313 transmits the non-public document information to the mobile terminal 5, while the mobile terminal 5 is determined to be inside the permission area.

In the first embodiment, the information transmitting unit 313 transmits the non-public document information to the mobile terminal 5 corresponding to the document ID received with the location information from the mobile terminal 5 inside the permission area. However, transmission enabling process of the non-public document information may be executed separately from transmitting the non-public document information and it is only necessary to ensure a state where the non-public document information can be transmitted to the mobile terminal 5 inside the permission area. In this case, the non-public document information may be transmitted corresponding to the document ID received separately from the location information.

The information transmitting unit 313 transmits the non-public document information with the area information of the permission area to the mobile terminal 5.

The mobile terminal 5 includes a screen 51, an imaging mechanism unit 52, a terminal control unit 53, and a terminal storage unit 54.

The screen 51, for example, is a touch panel type and functions as an operation unit that accepts operation inputs and a display unit that displays operation states. However, the screen 51 needs not necessarily to have a function as an operation unit.

The imaging mechanism unit 52, for example, is constituted of a Charge Coupled Device (CCD) camera, a Complementary Metal Oxide Semiconductor (CMOS) camera, or a similar component. The imaging mechanism unit 52 takes images such as the mark M (see FIG. 1) printed on the paper sheet in the first embodiment.

The terminal control unit 53 and the terminal storage unit 54 are configured similarly to the server control unit 31 and the server storage unit 32 of the document management server 3. The terminal control unit 53 is an arithmetic device such as CPU that performs operation controls for each portion of the mobile terminal 5. The terminal storage unit 54 is constituted of ROM, RAM, HDD, and a similar component.

The mobile terminal 5 of the first embodiment performs as a location information detecting unit 531, an identification information receiving unit 532, a browse requesting unit 533, a display processing unit 534, and an area monitoring unit 535, by the terminal control unit 53 executing the program in the terminal storage unit 54.

The location information detecting unit 531 ensures location information detecting functions and detects the location of the mobile terminal 5 (own apparatus) and can use Global Positioning System (GPS) or a similar system.

The identification information receiving unit 532 ensures Identification information receiving functions and accepts the input of the document ID to identify the non-public document information. The identification information receiving unit 532 of the first embodiment accepts the input of the document ID by imaging the mark M (see FIG. 1) on the paper sheet through the imaging mechanism unit 52. However, acceptance of the document ID may be performed through the operation input on the screen 51.

The browse requesting unit 533 ensures browse requesting functions and requests browsing of the non-public document information (hereinafter may be referred to as “browse request”) to the document management server 3 by transmitting the location information of the mobile terminal 5 (own apparatus). The browse requesting unit 533 of the first embodiment, corresponding to the image of mark M (see FIG. 1), performs a browse request by transmitting the location information of the mobile terminal 5 detected by the location information detecting unit 531 and the document ID acquired by the identification information receiving unit 532 to the document management server 3. However, the browse request can be performed corresponding to selection inputs of request buttons in the screen 51.

The display processing unit 534 ensures display processing functions, receiving the non-public document information from the document management server 3 and displaying it in the screen 51. As display methods, it is possible not only to simply display the non-public document information on the browser but also to use Augmented Reality (AR). When using AR, it is only necessary to take the image of the paper sheet that has the public document information by the imaging mechanism unit 52, and then, to superimpose the non-public document information on the paper sheet.

The display processing unit 534 of the first embodiment halts displaying the non-public document information on the screen 51, while the mobile terminal (own apparatus) 5 is outside the permission area through monitoring by the area monitoring unit 535 that will be described later.

At this time, the display processing unit 534 deletes the non-public document information received from the document management server 3. Therefore, in the first embodiment, it is ensured that the non-public document information is prevented from being left in the mobile terminal 5 and the display on the screen 51 is halted.

The area monitoring unit 535 ensures area monitoring functions and monitors whether or not the mobile terminal (own apparatus) 5 is situated inside the permission area based on the area information received from the document management server 3 and the location information of the mobile terminal (own apparatus) 5. This monitoring is continually performed as long as the display processing unit 534 displays the non-public document information.

### Document Browsing Process

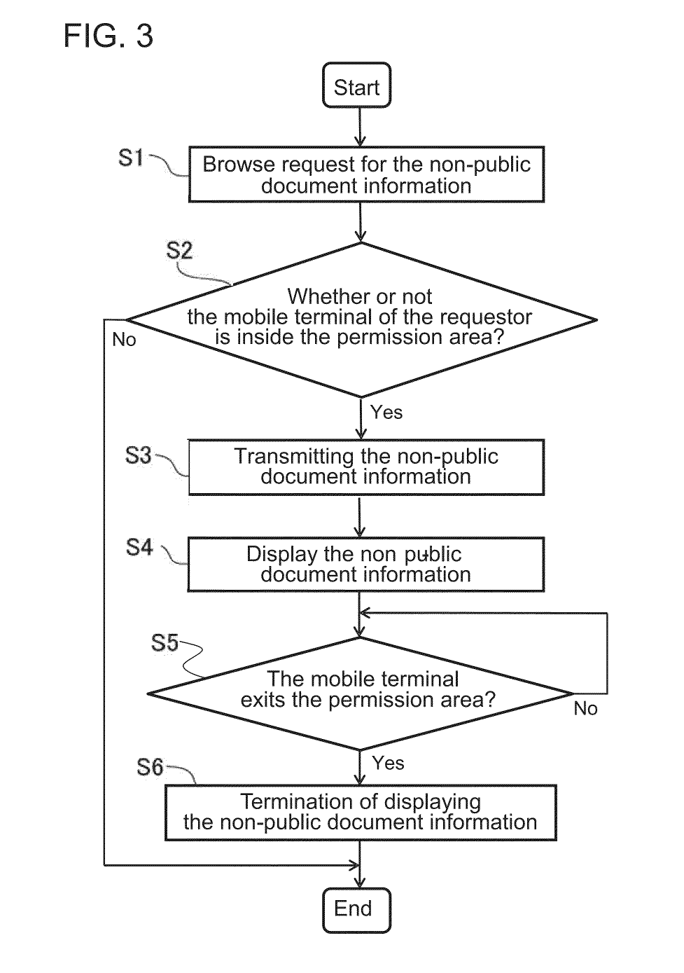

FIG. 3 illustrates steps of a document browsing process by the document browsing system according to the first embodiment. In the first embodiment, the following describes a case where a user carrying the mobile terminal 5 obtains the public document (see FIG. 1), in which the public document information and the mark M is printed out on the paper sheet, and browses the non-public document information generated in the same document with the public document using the mobile terminal 5. In the public document, the public document information are requested to print out in advance from the user terminal 2 or the image forming apparatus 4 and both the public document information and the mark M are printed out on the paper sheet.

In step S1, a process of “browse request for the non-public document information” is performed. In this process, first, the mark M on the public document is imaged through the imaging mechanism unit 52 of the mobile terminal 5. By imaging, the identification information receiving unit 532 of the mobile terminal 5 accepts the document ID of the non-public document information that corresponds to the public document and the location information detecting unit 531 detects the location information of the mobile terminal 5.

Then, the browse requesting unit 533 of the mobile terminal 5 transmits the document ID accepted by the identification information receiving unit 532 and the location information detected by the location information detecting unit 531 to the document management server 3 and requests browsing of the non-public document information.

Thus, when the browse request for the non-public document information is performed, the process proceeds to step S2.

In step S2, a process of “whether or not the mobile terminal of the requestor is inside the permission area?” is performed. That is, in this process, when both the location information and the document ID transmitted from the mobile terminal 5 are received at the document management server 3 side, the information transmitting unit 313 compares the location information of the mobile terminal 5 acquired by the location information acquisition unit 312 and the area information inside the server storage unit 32 to determine whether or not the mobile terminal 5 is inside the permission area.

When the location of the mobile terminal 5 is determined to be inside the permission area, the process proceeds to step S3 (YES), and when determined to be outside the permission area, this document browsing process terminates. When this document browsing process is terminated, the information transmitting unit 313 transmits a prohibition notice or similar information to the mobile terminal 5, notifying that the area is prohibited to browse the non-public document information. In the mobile terminal 5, the display processing unit 534 ensures displaying the prohibition notice or similar information on the screen 51.

In step S3, a process of “transmitting the non-public document information” is performed. In this process, the document information managing unit 311 of the document management server 3 retrieves the non-public document information from inside the server storage unit 32 based on the document ID received at step S2. The retrieved non-public document information is transmitted to the mobile terminal 5 from the information transmitting unit 313 of the document management server 3. At this time, the area information that identifies the range of the permission area is transmitted to the mobile terminal 5 with the non-public document information.

Thus, when step S3 is completed, the process proceeds to step S4.

In step S4, a process of “display of the non-public document information” is performed. In this process, when both the non-public document information and the area information from the document management server 3 are received at the mobile terminal 5 side, the display processing unit 534 displays the received non-public document information on the screen 51. Furthermore, the non-public document information and the area information received are temporarily stored in the terminal storage unit 54.

Thus, when step S4 is completed, the process proceeds to step S5.

In step S5, a process of “The mobile terminal exits the permission area?” is performed. In this process, the area monitoring unit 535 of the mobile terminal 5 determines whether or not the mobile terminal (own apparatus) 5 exits the permission area based on the area information received during displaying the non-public document information on the screen 51 and the location information in the location information detecting unit 531.

When the mobile terminal 5 is determined to exit the permission area, the process proceeds to step S6 (YES), and when the mobile terminal 5 is determined to be inside the permission area, the process repeats step S5 and continues displaying the non-public document information on the screen 51 (NO).

In step S6, a process of “termination of displaying the non-public document information” is performed. In this process, the display processing unit 534 of the mobile terminal 5 terminates displaying the non-public document information on the screen 51. At this time, for example, a notice such as the mobile terminal 5 outside the permission area is displayed on the screen 51 of the mobile terminal 5.

When the termination of displaying the non-public document information is performed, the display processing unit 534 deletes both the non-public document information and the area information stored inside the terminal storage unit 54. If the deletion of the information described above is performed first, the display of the non-public document information on the screen 51 can be terminated corresponding to the deletion.

It is also possible to perform the termination of displaying the non-public document information with operation inputs such as termination buttons on the screen 51 of the mobile terminal 5.

### Effect of First Embodiment

The document management server 3 of the first embodiment includes the document information managing unit 311, the location information acquisition unit 312, and the information transmitting unit 313. The document information managing unit 311 manages the freely browsable public document information and the non-public document information that is browsable inside the permission area. The location information acquisition unit 312 acquires the location information of the mobile terminal 5 to browse the non-public document information. The information transmitting unit 313 determines whether or not the mobile terminal 5 is inside the permission area based on the acquired location information and transmits the non-public document information to the mobile terminal 5 when the mobile terminal 5 is determined to be situated in the permission area.

Therefore, since the document management server 3 ensures browsing the non-public document information via the mobile terminal 5 while the mobile terminal 5 is inside the permission area. This securely ensures the prevention of the information leakage of the non-public document information.

In the document browsing system 1 that includes the document management server 3 and the mobile terminal 5, the mobile terminal 5 includes the browse requesting unit 533 and the display processing unit 534. The browse requesting unit 533 may request the browsing of the non-public document information by transmitting the location information of own apparatus to the document management server 3. The display processing unit 534 may display the non-public document information on the screen 51 by receiving it from the document management server 3.

Therefore, the document browsing system 1 ensures browsing the non-public document information on the screen 51 of the mobile terminal 5 corresponding to the browse request from the mobile terminal 5 inside the permission area, preventing securely the information leakage.

The mobile terminal 5 includes the Identification information receiving unit 532 that accepts the input of the document ID for identifying the non-public document information. The mobile terminal 5 may transmit the document ID that is received at the identification information receiving unit 532 along with the location information, to the document management server 3 when the browse requesting unit 533 requests browsing of the non-public document information. In the document management server 3, the information transmitting unit 313 may transmit the non-public document information that corresponds to the document ID to the mobile terminal 5 situated inside the permission area.

Therefore, the document browsing system 1 ensures transmitting only the non-public document information to which the browse request is done to the mobile terminal 5 and to browse it, thus more securely ensuring the prevention of the information leakage of the non-public document information.

The document information managing unit 311 of the document management server 3 of the first embodiment may control the public part and the non-public part in the same document information as the public document information and the non-public document information respectively, and may control for ensuring the print out of the document ID of the non-public document information with the public document information in the same document.

Therefore, the document browsing system 1 of the first embodiment, in managing the document information that contains the non-public document information, ensures printing out the public document information on a paper sheet (a paper medium) and to browse the non-public document information only in the browsable permission area, when the public document information and the non-public document information are mixed.

Moreover, with the use of the printed document ID (the mark M) printed with the public document information on the paper sheet, the mobile terminal 5 easily performs a browse request for the corresponding non-public document information.

In the mobile terminal 5, the Identification information receiving unit 532 may accept the input of the document ID (the mark M) printed out on the paper sheet by imaging the document ID and the browse requesting unit 533 may request browsing of the non-public document information corresponding to the acceptance of the input of the document ID.

Therefore, in the document browsing system 1 of the first embodiment, imaging the document ID (the mark M) with the mobile terminal 5 ensures requesting browsing of the non-public document information that corresponds to the public document information.

In the document management server 3, the document information managing unit 311 manages the area information that identifies the range of the permission area and the information transmitting unit 313 transmits the area information along with the non-public document information to the mobile terminal 5. The mobile terminal 5 may include the area monitoring unit 535 that monitors whether or not own apparatus is situated inside the permission area based on the area information received from the document management server 3 and the location information of own apparatus. The display processing unit 534 may cause the mobile terminal 5 to halt the display of the non-public document information on the screen 51 when own apparatus exits the range of the permission area through monitoring by the area monitoring unit 535.

Therefore, in the document browsing system 1 of the first embodiment, since browsing of the non-public document information with the mobile terminal 5 is allowed only while the mobile terminal 5 is situated inside the permission area, thus more securely ensuring the prevention of the information leakage of the non-public document information.

In this case, the display processing unit 534 of the mobile terminal 5 may delete the non-public document information received from the document management server 3. Therefore, the non-public document information will not be left in the mobile terminal 5, thus more securely ensuring the prevention of the information leakage of the non-public document information.

### Second Embodiment

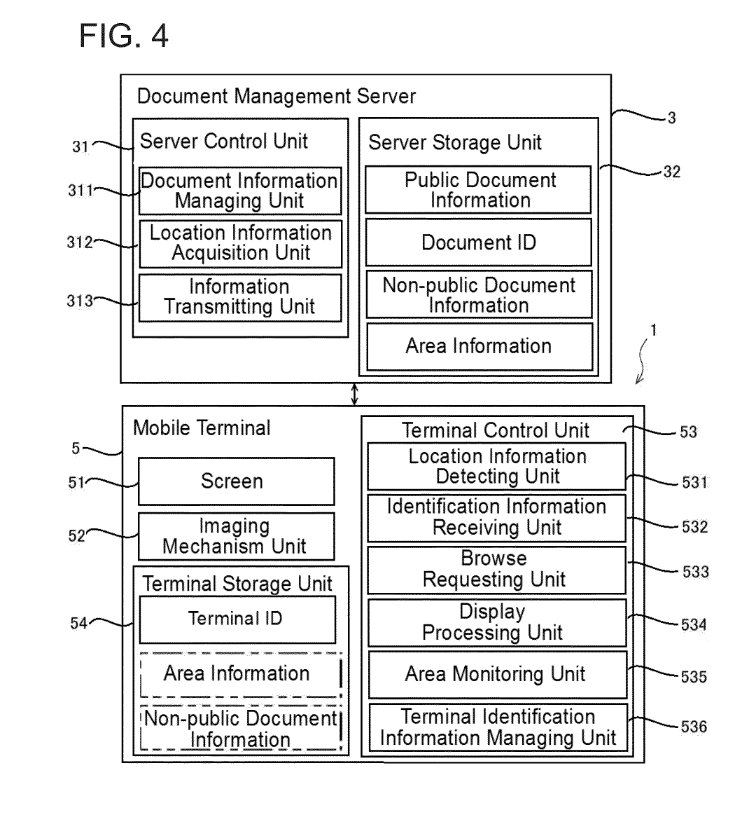

FIG. 4 illustrates a configuration of a document management server and a mobile terminal of a document browsing system according to a second embodiment. While in the above-described first embodiment the browsing of the non-public document information at the mobile terminal 5 is permitted or prohibited considering only the permission area, the second embodiment takes into consideration terminal identification information (herein after referred to as “terminal ID”) that identifies the mobile terminal 5.

In the second embodiment, the terminal control unit 53 of the mobile terminal 5 also functions as a terminal identification information managing unit 536. The terminal identification information managing unit 536 ensures terminal information managing functions and controls the terminal ID that identifies the mobile terminal (own apparatus) 5. The terminal ID is simply stored in the terminal storage unit 54.

The terminal ID along with the location information of the mobile terminal 5 and the document ID is transmitted to the document management server 3 when the browse requesting unit 533 performs a browse request.

On the other hand, in the document management server 3, the document information managing unit 311 controls the mobile terminals (terminal permission information) that are permitted to browse the non-public document information. For example, the document information managing unit 311 controls the list of the terminal IDs of the mobile terminals that are permitted to browse the non-public document information. In addition, a list of the terminal IDs of the mobile terminals that are prohibited to browse the non-public document information may be controlled.

The information transmitting unit 313 transmits the non-public document information to the mobile terminal 5 while the mobile terminal 5 situated inside the permission area is permitted to browse the non-public document information based on the terminal ID received from the mobile terminal 5.

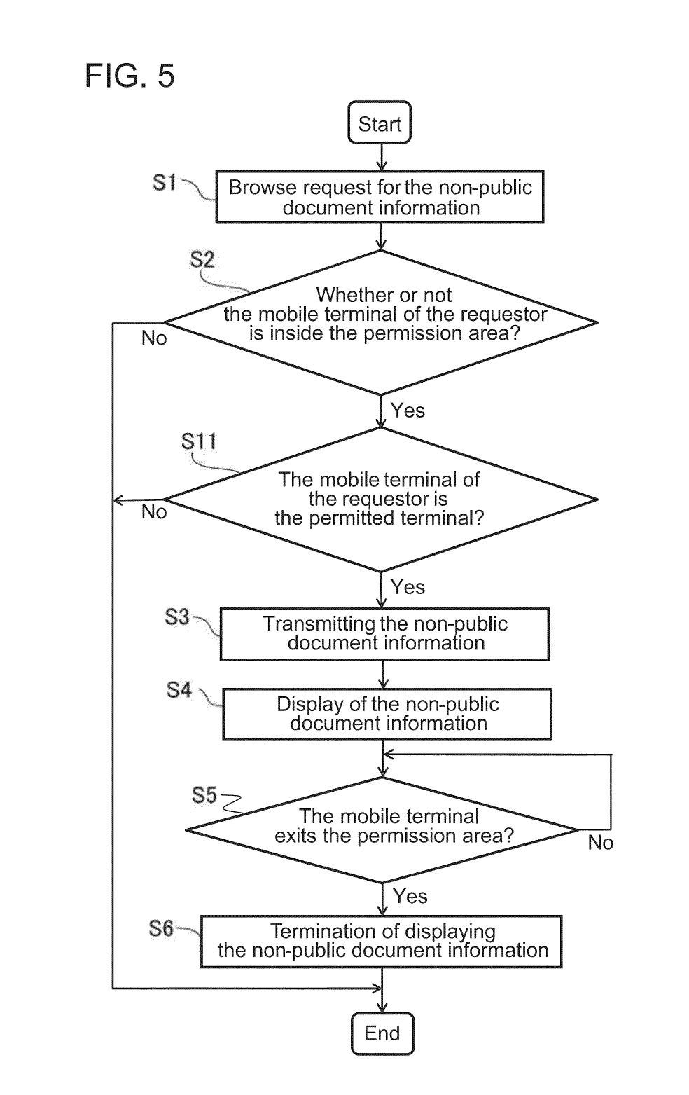

FIG. 5 illustrates steps of a document browsing process by the document browsing system according to the second embodiment. FIG. 5 is otherwise same as the sequence of steps of FIG. 3 except that FIG. 5 further includes step S11 in addition to the sequence of steps of FIG. 3.

That is, the document browsing process of the second embodiment proceeds to step S11, after “browse request for the non-public document information is performed” at step S1 and “whether or not the mobile terminal as the requestor is inside the permission area is determined” at step S2 in a similar way in FIG. 3.

In addition, In step S1 of FIG. 5, when browsing of the non-public document information is requested, the terminal ID of the mobile terminal 5 along with the document ID and the location information of the mobile terminal 5 is transmitted to the document management server 3.

In step S11, a process of “the mobile terminal of the requestor is the permitted terminal?” is performed. In the process, comparing the terminal ID of the mobile terminal 5 received by the document information managing unit 311 of the document management server 3 with the terminal permission information in the server storage unit 32, it is determined whether or not the mobile terminal 5 situated inside the permission area is permitted to browse the non-public document information.

The process proceeds to step S3 based on the permission for the mobile terminal 5 to browse the non-public document information and then performs the processes after step S3 in a similar way in FIG. 3 (YES). On the other hand, the document browsing process terminates based on the prohibition for the mobile terminal 5 to browse the non-public document information.

When the document browsing process terminates, a prohibition notice that the mobile terminal 5 is prohibited to browse the non-public document information is transmitted to the mobile terminal 5. In the mobile terminal 5, the display processing unit 534 ensures displaying the prohibition notice on the screen 51 of the mobile terminal 5.

The second embodiment, in addition to being able to achieve the operations and effects similar to the above-described first embodiment, ensures browsing the non-public document information at the mobile terminal 5 only when the mobile terminal 5 is situated in the permission area and is permitted to browse the non-public document information.

Therefore, the second embodiment ensures restricting browsing of the non-public document information from both the location of the mobile terminal 5 and the owner, thus more securely ensuring the prevention of the information leakage of the non-public document information.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A document management server, comprising:
a document information managing unit that controls public document information and non-public document information, the public document information being freely browsable, the non-public document information being browsable inside a permission area;
a location information acquisition unit that acquires location information of a mobile terminal to browse the non-public document information; and
an information transmitting unit that determines whether or not the mobile terminal is inside the permission area based on the acquired location information and transmit the non-public document information to the mobile terminal while the mobile terminal is determined to be in the permission area.

2. A document browsing system, comprising:
a document management server; and
a mobile terminal,
wherein the document management server includes:
a document information managing unit that controls public document information and non-public document information, the public document information being freely browsable, the non-public document information being browsable inside a permission area;
a location information acquisition unit that acquires location information of a mobile terminal to browse the non-public document information; and
an information transmitting unit that determines whether or not the mobile terminal is inside the permission area based on the acquired location information and transmit the non-public document information to the mobile terminal while the mobile terminal is determined to be in the permission area,
wherein the mobile terminal includes:
a browse requesting unit that transmits the location information of the mobile terminal to request browsing of the non-public document information; and
a display processing unit that receives the non-public document information from document management server and display the received non-public document information on a screen.

3. The document browsing system according to claim 2,
wherein the mobile terminal includes an identification information receiving unit that accepts input of document identification information that identifies the non-public document information,
the browse requesting unit is that transmits the document identification information accepted along with the location information when requesting the browsing, and
the information transmitting unit is that transmits the non-public document information that corresponds to the document identification information to the mobile terminal situated in the permission area.

4. The document browsing system according to claim 3,
wherein the document management server includes a document information managing unit that: respectively controls a public part and a non-public part in a same document as the public document information and the non-public document information, and control the document identification information of the non-public document information along with the public document information in the same document to be printed out on a paper sheet.

5. The document browsing system according to claim 4,
wherein the identification information receiving unit images the document identification information printed out on the paper sheet to accept the input of the document identification information, and
the browse requesting unit requests the browsing in response to the acceptance of the input of the document identification information.

6. The document browsing system according to claim 2,
wherein the mobile terminal includes a terminal identification information managing unit that controls terminal identification information to identify the mobile terminal,
the browse requesting unit transmits the terminal identification information to the document management server when requesting the browsing,
the document information managing unit manages the mobile terminal permitted to browse the non-public document information, and
the information transmitting unit transmits the non-public document information to the mobile terminal when the mobile terminal situated in the permission area is permitted to browse the non-public document information based on the terminal identification information received from the mobile terminal.

7. The document browsing system according to claim 2,
wherein the document information managing unit manages area information that identify a range of the permission area,
the information transmitting unit transmits the area information along with the non-public document information to the mobile terminal, and
the mobile terminal includes an area monitoring unit that monitors whether or not the mobile terminal is inside the permission area based on the area information received from the document management server and the location information of the mobile terminal, and
the display processing unit halts the display of the non-public document information while the mobile terminal is situated outside the permission area by the monitoring.

8. The document browsing system according to claim 7,
wherein the display processing unit deletes the non-public document information received from the document management server while halting the display on the screen.

9. A non-transitory computer-readable recording medium storing a document management server program, the document management server program causing a computer to function as:
a document information managing unit that controls public document information and non-public document information, the public document information being freely browsable, the non-public document information being browsable inside a permission area;
a location information acquisition unit that acquires location information of a mobile terminal to browse the non-public document information; and
an information transmitting unit that determines whether or not the mobile terminal is inside the permission area based on the acquired location information and transmit the non-public document information to the mobile terminal while the mobile terminal is determined to be in the permission area.

10. The non-transitory computer-readable recording medium according to claim 9, the document management server program causing the computer to function as:
a browse requesting unit that causes the mobile terminal to transmit the location information of the mobile terminal to request browsing of the non-public document information; and
a display processing unit that causes the mobile terminal to receive the non-public document information transmitted by the information transmitting unit and display the non-public document information on a screen of the mobile terminal.
